(19) United States
(12) Patent Application Publication
(10) Pub. No.: US 2023/0289327 A1
(43) Pub. Date: Sep. 14, 2023

(54) FAILURE HINTING FOR SITE PREPARATION IN MULTI-SITE DATA REPLICATION ENVIRONMENT

(71) Applicant: International Business Machines Corporation, Armonk, NY (US)

(72) Inventors: Sarvesh S. Patel, Pune (IN); Swapnil Dattatraya Joshi, Pune (IN); Kushal S. Patel, Pune (IN); Subhojit Roy, Pune (IN)

(73) Assignee: International Business Machines Corporation, Armonk, NY (US)

(21) Appl. No.: 17/691,447

(22) Filed: Mar. 10, 2022

(51) Int. Cl. G06F 16/178; G06N 7/00

(52) U.S. Cl. CPC G06F 16/178; G06N 7/005

(57) ABSTRACT

A method for preparing for a failure in a multi-site data replication environment is disclosed. In one embodiment, such a method includes detecting, at a primary site of a multi-site data replication environment, conditions indicating that a failure is impending at the primary site. The method further determines a probability that the impending failure will occur. The method sends, from the primary site to at least one other site of the multi-site data replication environment, a message informing the at least one other site of the impending failure and its probability. In the event the probability has reached a threshold, the method prepares the at least one other site for the impending failure before it actually occurs. A corresponding computer program product and system are also disclosed.

### BACKGROUND

### Field of the Invention

This invention relates to systems and methods for preparing for failures in multi-site data replication environments.

### Background of the Invention

Data is often one of an organization's most valuable assets. Accordingly, it is paramount that an organization regularly back up its data, particularly its business-critical data. Statistics show that a large percentage of organizations are unable to recover from an event of significant data loss, regardless of whether the loss is the result of a virus, data corruption, physical disaster, software or hardware failure, human error, or the like. At the very least, significant data loss can result in lost income, missed business opportunities, and/or substantial legal liability. Accordingly, it is important that an organization implement adequate data protection policies and procedures to prevent such losses from occurring.

Multi-site data replication refers to technologies that enable enterprises to maintain and replicate multiple copies of their business-critical data at different geographically dispersed locations. In some cases, multi-site data replication may be mandated by government for business-critical applications, such as those used by banks and other financial institutions. In such data replication environments, when a failure occurs at one site, I/O may be redirected to another site in the environment and the environment may be reconfigured to account for the failure. Unfortunately, switching I/O from one site to another and reconfiguring the multi-site data replication environment may be quite complex and result in delays or increased I/O latency, or even application failures or host crashes.

### SUMMARY

The invention has been developed in response to the present state of the art and, in particular, in response to the problems and needs in the art that have not yet been fully solved by currently available systems and methods. Accordingly, the invention has been developed to prepare for failures in multi-site data replication environments. The features and advantages of the invention will become more fully apparent from the following description and appended claims, or may be learned by practice of the invention as set forth hereinafter.

Consistent with the foregoing, a method for preparing for a failure in a multi-site data replication environment is disclosed. In one embodiment, such a method includes detecting, at a primary site of a multi-site data replication environment, conditions indicating that a failure is impending at the primary site. The method further determines a probability that the impending failure will occur. The method sends, from the primary site to at least one other site of the multi-site data replication environment, a message informing the at least one other site of the impending failure and its probability. In the event the probability has reached a threshold, the method prepares the at least one other site for the impending failure before it actually occurs.

A corresponding computer program product and system are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a network environment in which systems and methods in accordance with the invention may be implemented;

FIG. 2 is a high-level block diagram showing one example of a storage system for use in the network environment of FIG. 1;

FIG. 3 is a high-level block diagram showing one example of a multi-site data replication environment;

FIG. 4 is a high-level block diagram showing virtual machines in the multi-site data replication environment of FIG. 3;

FIG. 5 is a high-level block diagram showing reconfiguration of the multi-site data replication environment of FIG. 3 after a failure has occurred;

FIG. 6 is a high-level block diagram showing a technique for preparing sites of a multi-site data replication environment for an impending failure; and

FIG. 7 is a high-level block diagram showing reconfiguration of the multi-site data replication environment using the technique shown in FIG. 6.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer-implemented process, such that the instructions which execute on the computer, other programmable apparatus, or other device implement the functions/acts specified in the flowchart and/or block diagram block or blocks.

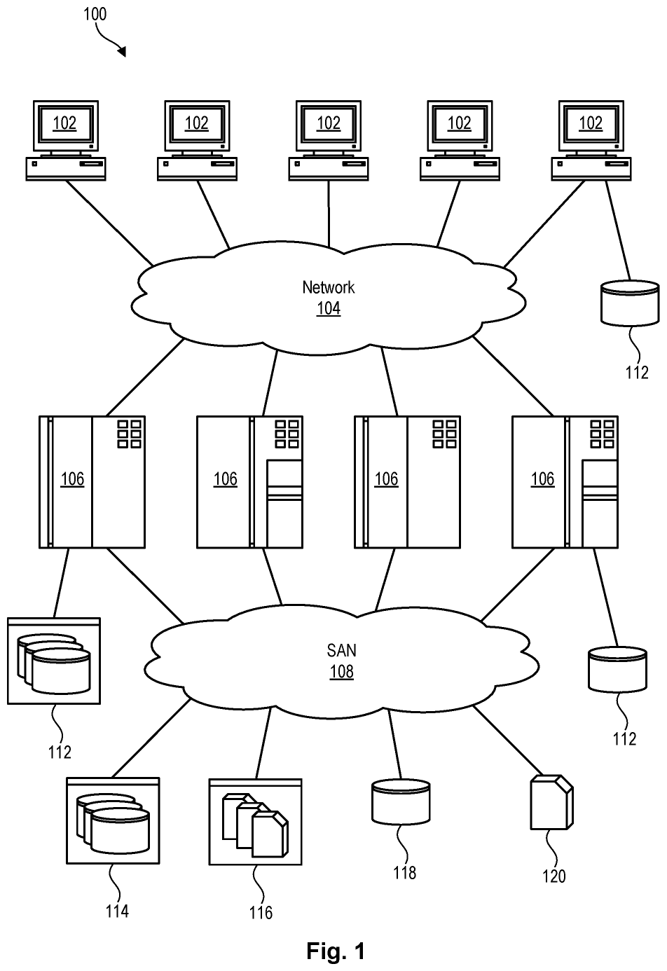

Referring to FIG. 1, one example of a network environment 100 is illustrated. The network environment 100 is presented to show one example of an environment where embodiments of the invention may operate. The network environment 100 is presented only by way of example and not limitation. Indeed, the systems and methods disclosed herein may be applicable to a wide variety of different network environments in addition to the network environment 100 shown.

As shown, the network environment 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “hosts” 106 or “host systems” 106). In general, the client computers 102 initiate communication sessions, whereas the server computers 106 wait for and respond to requests from the client computers 102. In certain embodiments, the computers 102 and/or servers 106 may connect to one or more internal or external direct-attached storage systems 112 (e.g., arrays of hard-disk drives, solid-state drives, tape drives, etc.). These computers 102, 106 and direct-attached storage systems 112 may communicate using protocols such as ATA, SATA, SCSI, SAS, Fibre Channel, or the like.

The network environment 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems 114, 116, 118, 120, such as arrays 114 of hard-disk drives or solid-state drives, tape libraries 116, individual hard-disk drives 118 or solid-state drives 118, tape drives 120, CD-ROM libraries, or the like. To access a storage system 114, 116, 118, 120, a host system 106 may communicate over physical connections from one or more ports on the host 106 to one or more ports on the storage system 114, 116, 118, 120. A connection may be through a switch, fabric, direct connection, or the like. In certain embodiments, the servers 106 and storage systems 114, 116, 118, 120 may communicate using a networking standard such as Fibre Channel (FC) or iSCSI.

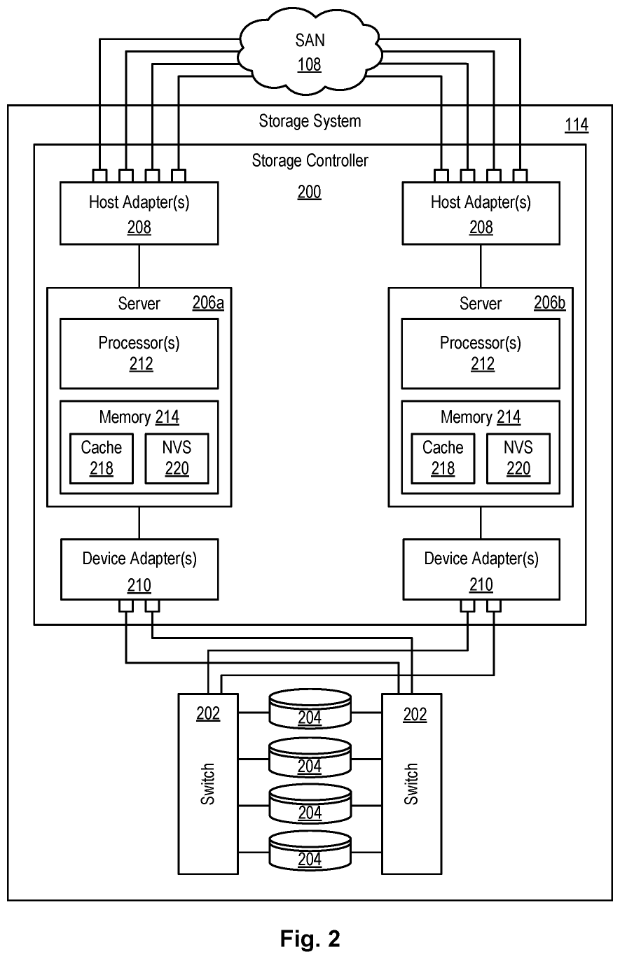

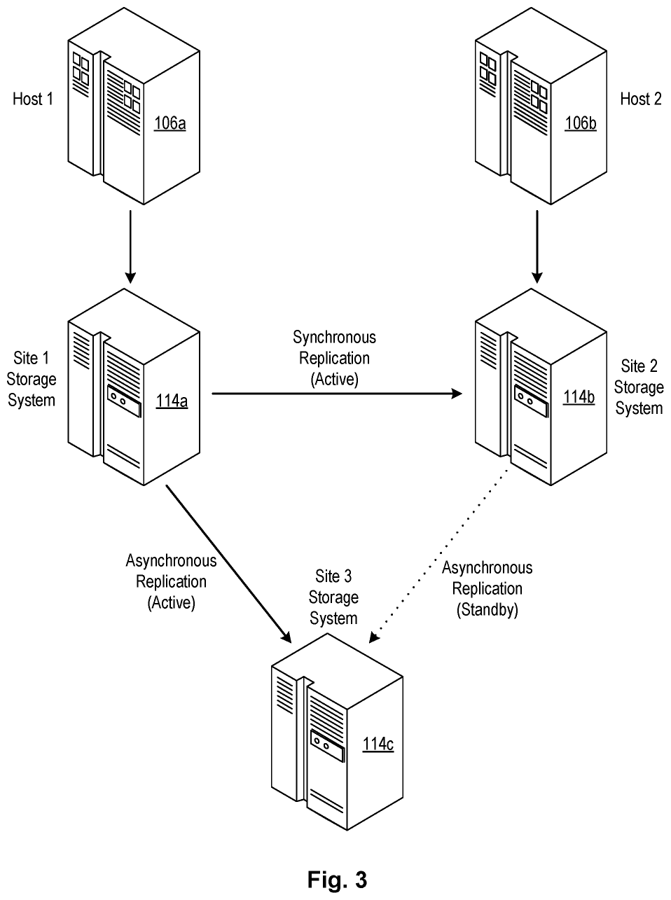

Referring to FIG. 2, one embodiment of a storage system 114 containing an array of storage drives 204 (e.g., hard-disk drives and/or solid-state drives) is illustrated. As shown, the storage system 114 includes a storage controller 200, one or more switches 202, and one or more storage drives 204 such as hard disk drives and/or solid-state drives (such as flash-memory-based drives). The storage controller 200 may enable one or more hosts 106 (e.g., open system and/or mainframe servers 106) to access data in the one or more storage drives 204. The storage drives 204 may, in certain embodiments, be configured in RAID arrays of various RAID levels to provide desired levels of I/O performance and/or data redundancy. Logical volumes 302 (as shown in FIG. 3) may be carved from these RAID arrays.

In selected embodiments, the storage controller 200 includes one or more servers 206. The storage controller 200 may also include host adapters 208 and device adapters 210 to connect the storage controller 200 to host devices 106 and storage drives 204, respectively. During normal operation (when both servers 206 are operational), the servers 206 may manage I/O to different logical subsystems (LSSs) within the enterprise storage system 114. For example, in certain configurations, a first server 206a may handle I/O to even LSSs, while a second server 206b may handle I/O to odd LSSs. These servers 206a, 206b may provide redundancy to ensure that data is always available to connected hosts 106. Thus, when one server 206a fails, the other server 206b may pick up the I/O load of the failed server 206a to ensure that I/O is able to continue between the hosts 106 and the storage drives 204. This process may be referred to as a “failover.”

In selected embodiments, each server 206 includes one or more processors 212 and memory 214. The memory 214 may include volatile memory (e.g., RAM) as well as non-volatile memory (e.g., ROM, EPROM, EEPROM, flash memory, local disk drives, local solid state drives etc.). The volatile and non-volatile memory may, in certain embodiments, store software modules that run on the processor(s) 212 and are used to access data in the storage drives 204. These software modules may manage all read and write requests to logical volumes 302 in the storage drives 204.

In selected embodiments, the memory 214 includes a cache 218, such as a DRAM cache 218. Whenever a host 106 (e.g., an open system or mainframe server 106) performs a read operation, the server 206 that performs the read may fetch data from the storages drives 204 and save it in its cache 218 in the event it is required again. If the data is requested again by a host 106, the server 206 may fetch the data from the cache 218 instead of fetching it from the storage drives 204, saving both time and resources. Similarly, when a host 106 performs a write, the server 106 that receives the write request may store the write in its cache 218, and destage the write to the storage drives 204 at a later time. When a write is stored in a cache 218, the write may also be stored in non-volatile storage (NVS) 220 of the opposite server 206 so that the write can be recovered by the opposite server 206 in the event the first server 206 fails.

One example of a storage system 114 having an architecture similar to that illustrated in FIG. 2 is the IBM DS8000® enterprise storage system. The DS8000® is a high-performance, high-capacity storage controller providing disk and solid-state storage that is designed to support continuous operations. Nevertheless, the systems and methods disclosed herein are not limited to the IBM DS8000® enterprise storage system, but may be implemented in any comparable or analogous storage system or group of storage systems, regardless of the manufacturer, product name, or components or component names associated with the system. Any storage system that could benefit from one or more embodiments of the invention is deemed to fall within the scope of the invention. Thus, the IBM DS8000® is presented only by way of example and is not intended to be limiting.

Referring to FIG. 3, multi-site data replication refers to technologies that enable enterprises to maintain and replicate multiple copies of their business-critical data at different geographically dispersed locations. In some cases, multi-site data replication may be mandated by the government for business-critical applications, such as those used by banks and other financial institutions.

FIG. 3 shows one example a multi-site data replication environment, in this example an environment with three geographically dispersed storage systems 114a-c, such as the storage system 114 described in FIG. 2. Under normal operating conditions, a storage system 114a and host system 106a, located at a first site, may function as the primary site. The primary host system 106a may perform I/O (i.e., reads and/or writes) to the primary storage system 114a. Writes to the primary storage system 114a may then be mirrored (i.e., replicated) to a secondary storage system 114b at a secondary site. In the illustrated example, the writes are synchronously mirrored from the primary storage system 114a to the secondary storage system 114b.

When operating synchronously, a write request may only be considered complete when it has completed successfully on both the primary and secondary storage systems 114a, 114b. By contrast, asynchronous operation may only require that the write complete on the primary storage system 114a before the write is considered complete. That is, a write acknowledgement may be returned to a host system 106a when the write has completed on the primary storage system 114a, without requiring that the write also be completed on the secondary storage system 114b. The write may then be mirrored from the primary storage system 114a to the secondary storage system 114b as time and resources allow to create a consistent copy of the write data on the secondary storage system 114b.

As also shown in the multi-site configuration of FIG. 3, when data is written to the primary storage system 114a, the data may also be mirrored from the primary storage system 114a to a tertiary storage system 114c. In this example, the data is asynchronously mirrored from the primary storage system 114a to the tertiary storage system 114c. Thus, in the illustrated embodiment, data that is written to the primary storage system 114a may be replicated to both the secondary storage system 114b and the tertiary storage system 114c, thereby providing a three-site data replication environment.

In the illustrated example, the multi-site data replication environment is configured in a star topology. That is, data is mirrored from the primary storage system 114a to both the secondary storage system 114b and the tertiary storage system 114c. In other embodiments, a cascade topology may be used. For example, data that is written to the primary storage system 114a may first be mirrored (synchronously or asynchronously) from the primary storage system 114a to the secondary storage system 114b, after which it may be mirrored (synchronously or asynchronously) from the secondary storage system 114b to the tertiary storage system 114c.

As further shown in FIG. 3, in certain embodiments, a link may exist between the secondary storage system 114b and the tertiary storage system 114c to asynchronously mirror data therebetween. Under normal operating conditions, this link may be in standby mode. In the event the primary storage system 114a experiences a failure, however, the secondary storage system 114b may temporarily act as the primary storage system and the link may be activated to mirror write data from the secondary storage system 114b to the tertiary storage system 114c.

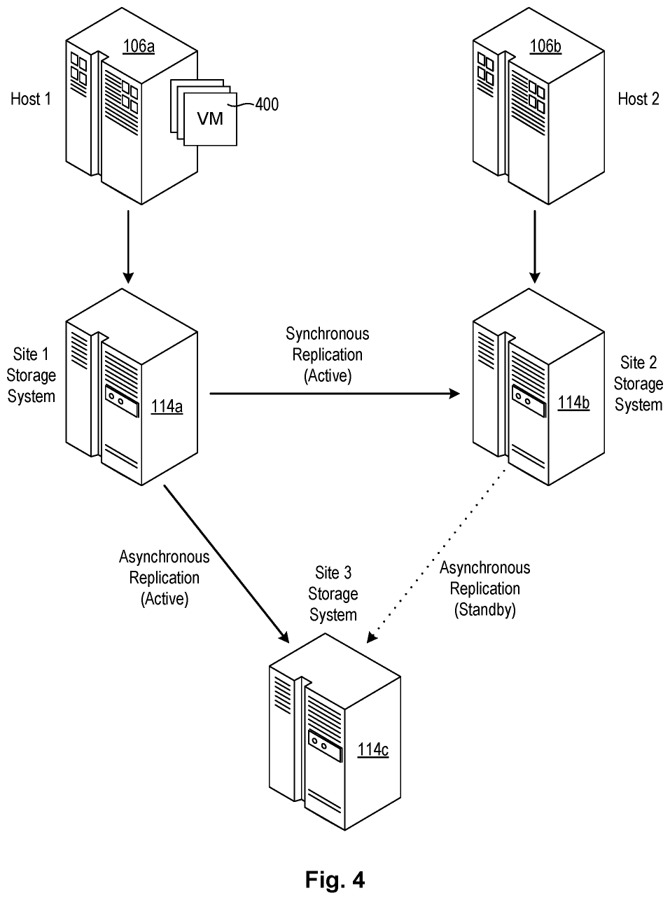

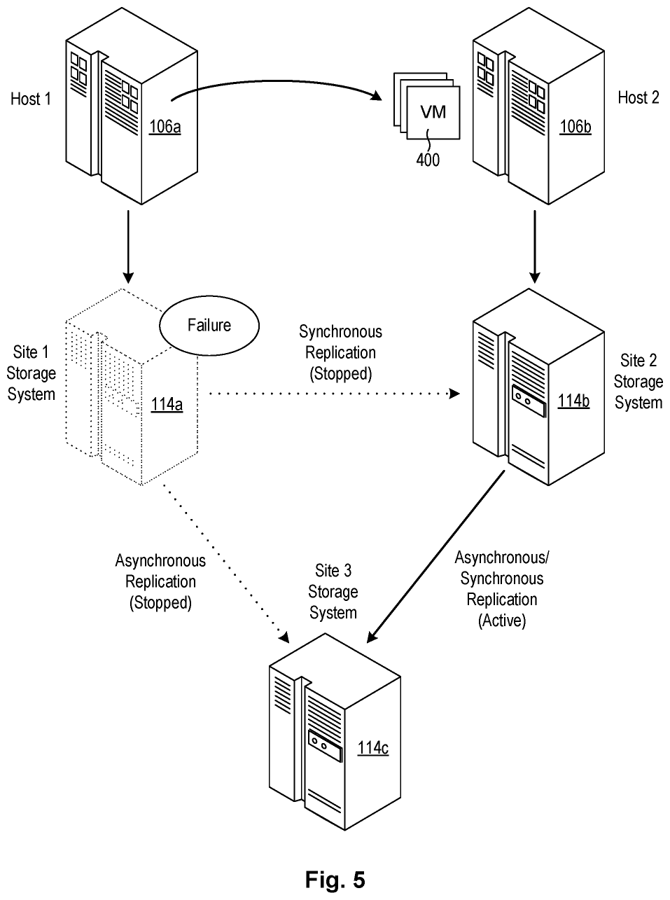

Referring to FIG. 4, under normal operating conditions, all hosts 106 and applications perform I/O through the primary storage system 114a. Virtual machines 400 may be resident on the host system 106a to access data on the primary storage system 114a. In the event the primary storage system 114a fails, the virtual machines 400 may be moved from the primary site to the secondary site (i.e., deactivated on the host system 106a and activated on the host system 106b) and I/O may be served from the host system 106b to the secondary storage system 114b, as shown in FIG. 5. The data replication link between the primary storage system 114a and the secondary storage system 114b and the data replication link between the primary storage system 114a and the tertiary storage system 114c may be stopped. The synchronous/asynchronous data replication link between the secondary storage system 114b and the tertiary storage system 114c may be activated.

Unfortunately, switching I/O from one site to another and reconfiguring the multi-site data replication environment in the manner described in FIG. 5 may be quite complex and result in delays or increased I/O latency. For example, significant time and resources may be needed to move virtual machines 400 and applications from the primary site to the secondary site and to suspend some data replication links while activating others. In some cases, reconfiguring the multi-site data replication environment in response to a failure at the primary site may require creating new host objects, performing volume mapping, modifying a topology of the data replication environment (e.g., from star to cascade or vice versa), converting some data replication links from asynchronous to synchronous operation or vice versa. Each of these actions may take time to complete and cause delays in resuming I/O in the multi-site data replication environment.

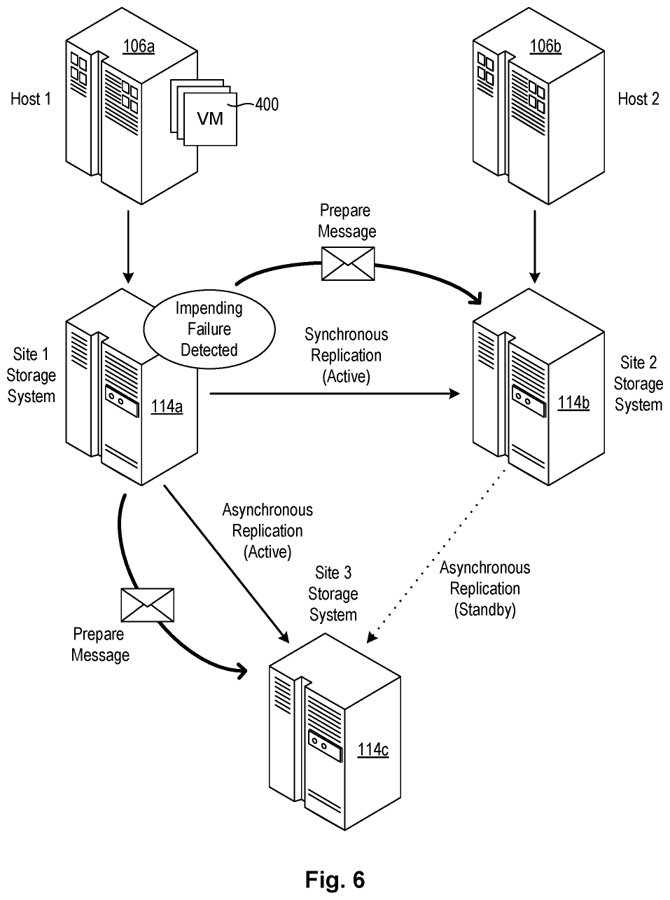

Referring to FIG. 6, in certain embodiments, it may be advantageous to provide functionality to prepare for a failure in a multi-site data replication environment, such as the environment illustrated in FIGS. 3-5. For example, if sites in a multi-site data replication environment could receive advance warning of an impending failure, the sites could begin reconfiguring the multi-site data replication environment before the failure actually occurs. If and when the failure does occur, the multi-site data replication environment could be mostly configured to quickly failover and resume I/O with as little delay or impact as possible.

In certain embodiments, in order to prepare for impending failures, sites in the multi-site data replication environment may be configured to send messages to other sites to provide notice of an impending failure. For example, as shown in FIG. 6, if the primary storage system 114a detects conditions that indicate that a failure may be imminent or forthcoming, the primary storage system 114a may send “prepare messages” to other sites in the multi-site data replication environment. In certain embodiments, the “prepare messages” are only sent (or acted upon) if the probability of failure has reached a selected threshold.

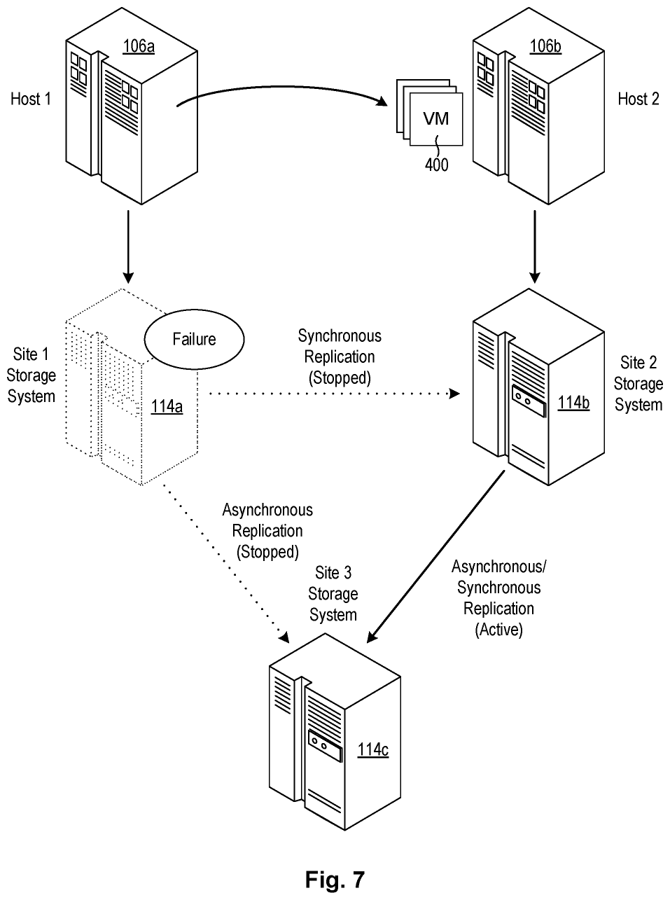

Upon receiving the message, the other sites may decode the “prepare messages” and begin preparing for the failure and resulting failover (e.g., bringing up the secondary host system 106b, moving virtual machines from one host system 106 to another, creating new host objects, mapping volumes, modifying topologies, activating data replication links, converting data mirroring relationships from asynchronous to synchronous or vice versa, mapping snapshots between storage systems 114 to get consistent copies, etc.). All of these tasks may be performed in parallel with continuing to process I/O at the primary storage system 114a. In certain embodiments, a new configuration is determined (i.e., precooked) beforehand and the “prepare messages” enable the sites to prepare to implement this new configuration before the failure occurs. Once the failure does occur, as shown in FIG. 7, the preparations may enable the new configuration to be implemented quickly to minimize delays or downtime. This technique prevents sites in the multi-site data replication environment from having to wait for a failure to occur or for a node (e.g., storage system 114) to go offline before beginning to prepare for a configuration change.

Various different use cases are possible using the technique illustrated in FIGS. 6 and 7. For example, if the primary storage system 114a experiences a power outage and is temporarily operating on battery power, the primary storage system 114a may begin dumping data from its cache 218 to persistent storage 204 to preserve the data and prepare for a shutdown (assuming power is not restored). Functionality may be provided within the primary storage system 114a to detect such a condition and send “prepare messages” to other sites in the multi-site data replication environment to warn them of the impending shutdown. In certain embodiments, the primary storage system 114a may include, in the “prepare messages,” a probability indicating how likely the failure is to occur, assuming such information can be obtained or calculated. This may enable the other sites to make an informed decision about what preparations need to be made and the likelihood that the failure will actually occur.

In another use case, an intrusion detection system may be utilized that monitors network utilization and volume access patterns at sites within the multi-site data replication environment. If irregular access patterns are detected on the primary storage system 114a (indicating possible unauthorized or prohibited activity), the intrusion detection system may lock the primary storage system 114a if the irregular access patterns reach a certain threshold of activity. When such irregular access patterns are detected and have reached the certain threshold, but before the primary storage system 114a is actually locked or shut down, functionality at the primary storage system 114a may send “prepare messages” to other sites in the multi-site data replication environment to warn them of the impending lock or failure so that they can begin preparations for the failover. When the failover does occur, I/O may be resumed (e.g., to the secondary storage system 114b) with as little delay or interruption as possible.

The “prepare messages” may be communicated between the sites in the multi-site data replication environment using any suitable communication path. For example, in certain embodiments, the “prepare messages” may be communicated over “in band” communication paths that are also used to transmit data between the sites. In other embodiments, the “prepare messages” are communicated over “out of band” communication paths (e.g., ethernet) that are separate from those used to transmit data. In certain embodiments, application programming interfaces (APIs) may be established to allow the “prepare messages” to be sent and received by the different sites of the multi-site data replication environment.

Similarly, in addition to the probability information previously discussed, the “prepare messages” may contain other types of information. For example, the “prepare messages” may include information such as information identifying the site and/or device where the failure is predicted to occur, an estimated time (or remaining time) when the failure will occur as well as the units in which the time is measured (e.g., seconds, minutes, hours, etc.), information identifying other sites that have relationships with the site that is about to fail, host clusters that perform I/O on the site that is about to fail or other sites in the multi-site data replication environment, a number or percentage that represents a probability that the site will fail, as well as the cause or type of failure (e.g., power loss, intrusion lock, overheating, system crash, etc.). Each of these types of information may be helpful in determining what the correct response should be. For example, the multi-site data replication environment may be configured one way for a first type of failure and another way for a second type of failure.

The flowcharts and block diagrams in the Figures illustrate the architecture, functionality, and operation of possible implementations of systems, methods, and computer-usable media according to various embodiments of the present invention. In this regard, each block in the flowcharts or block diagrams, or functionality described herein, may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for preparing for a failure in a multi-site data replication environment, the method comprising:
detecting, at a primary site of a multi-site data replication environment, conditions indicating that a failure is impending at the primary site;
determining a probability that the impending failure will occur;
sending, from the primary site to at least one other site of the multi-site data replication environment, a message informing the at least one other site of the impending failure and its probability; and
in the event the probability has reached a threshold, preparing, by the at least one other site, the multi-site data replication environment for the impending failure prior to its occurrence.

2. The method of claim 1, wherein preparing comprises preparing to convert a data mirroring relationship within the multi-site data replication environment from asynchronous data replication to synchronous data replication.

3. The method of claim 1, wherein preparing comprises preparing to modify a topology of the multi-site data replication environment.

4. The method of claim 1, wherein preparing comprises preparing another site in the multi-site data replication environment to act as the primary site.

5. The method of claim 1, wherein the message further identifies the site in the multi-site data replication environment that is predicted to fail.

6. The method of claim 1, wherein the message further provides an estimation of when the impending failure will occur.

7. The method of claim 1, wherein the message further identifies a cause of the impending failure.

8. A computer program product for preparing for a failure in a multi-site data replication environment, the computer program product comprising a non-transitory computer-readable storage medium having computer-usable program code embodied therein, the computer-usable program code configured to perform the following when executed by at least one processor:
detect, at a primary site of a multi-site data replication environment, conditions indicating that a failure is impending at the primary site;
determine a probability that the impending failure will occur;
send, from the primary site to at least one other site of the multi-site data replication environment, a message informing the at least one other site of the impending failure and its probability; and
in the event the probability has reached a threshold, prepare, by the at least one other site, the multi-site data replication environment for the impending failure prior to its occurrence.

9. The computer program product of claim 8, wherein preparing comprises preparing to convert a data mirroring relationship within the multi-site data replication environment from asynchronous data replication to synchronous data replication.

10. The computer program product of claim 8, wherein preparing comprises preparing to modify a topology of the multi-site data replication environment.

11. The computer program product of claim 8, wherein preparing comprises preparing another site in the multi-site data replication environment to act as the primary site.

12. The computer program product of claim 8, wherein the message further identifies the site in the multi-site data replication environment that is predicted to fail.

13. The computer program product of claim 8, wherein the message further provides an estimation of when the impending failure will occur.

14. The computer program product of claim 8, wherein the message further identifies a cause of the impending failure.

15. A system for preparing for a failure in a multi-site data replication environment, the system comprising:
at least one processor;
at least one memory device operably coupled to the at least one processor and storing instructions for execution on the at least one processor, the instructions causing the at least one processor to:
detect, at a primary site of a multi-site data replication environment, conditions indicating that a failure is impending at the primary site;
determine a probability that the impending failure will occur;
send, from the primary site to at least one other site of the multi-site data replication environment, a message informing the at least one other site of the impending failure and its probability; and
in the event the probability has reached a threshold, prepare, by the at least one other site, the multi-site data replication environment for the impending failure prior to its occurrence.

16. The system of claim 15, wherein preparing comprises preparing to convert a data mirroring relationship within the multi-site data replication environment from asynchronous data replication to synchronous data replication.

17. The system of claim 15, wherein preparing comprises preparing to modify a topology of the multi-site data replication environment.

18. The system of claim 15, wherein preparing comprises preparing another site in the multi-site data replication environment to act as the primary site.

19. The system of claim 15, wherein the message further identifies the site in the multi-site data replication environment that is predicted to fail.

20. The system of claim 15, wherein the message further provides an estimation of when the impending failure will occur.
